(19) United States
(12) Patent Application Publication
(10) Pub. No.: US 2008/0008463 A1
(43) Pub. Date: Jan. 10, 2008

(54) Actuator, and lens unit camera with the same

(76) Inventors: Hiroshi Otsuka, Saitama-shi (JP); Takayoshi Noji, Saitama-shi (JP); Toshinori Akutsu, Saitama-shi (JP)

Correspondence Address: JACOBSON HOLMAN PLLC, 400 SEVENTH STREET N.W., SUITE 600, WASHINGTON, DC, 20004, US

(21) Appl. No.: 11/822,608

(22) Filed: Jul. 9, 2007

(30) Foreign Application Priority Data
Jul. 7, 2006 (JP) 2006-188274

(51) Int. Cl. G03B 5/00

(52) U.S. Cl. 396/55; 396/52

(57) ABSTRACT

The present invention is directed to an actuator capable of locking a movable member without additional purpose-made components such as a lock ring, and another actuator used to drive them.

The actuator (10) of the present invention is used to translate a photographing lens and prevent an image from shaking, and the actuator comprises a fixed member (12), a movable member (14) holding the photographing lens, a supporting means (18) movably supporting the movable member, a driving means (20, 22) translating and rotating the movable member, at least three engaging portions (17) disposed in the movable member, at least three receiving portions (15) that are to catch the engaging portions upon rotating the movable member to a predetermined locking position, magnetic attracting means (22, 23) disposed separately in both the fixed member and the movable member. The magnetic attracting means, when they come close to each other, attract each other and develop a force to rotate the movable member, so that the engaging portions press on the receiving portions to lock the movable member in position.

### DESCRIPTION

1. Field of the Invention

The present invention relates to an actuator, and a lens unit and a camera with the actuator, and more particularly, it relates to an image-shake compensating actuator that translates a photographing lens within a plane orthogonal to an optical axis of the lens, and a lens unit and a camera with the same.

2. Background of the Related Art

Japanese Patent No. 3397536 (Patent Document 1) discloses an optical compensating device. The optical compensating device has a compensating lens deviating an optical axis of optics, and a lock ring holding the compensating lens stationary. The lock ring is annular in shape, surrounding the compensating lens, and has its inner surface provided with cams that are to be engaged with a frame the compensating lens is fixed to. The optical compensating device, when not in use for the compensating operation, is held stationary by revolving the lock ring that surrounds the compensating lens so as to engage cams in an inner circumference of the lock ring with an outer circumference of the frame of the compensating lens.

Patent Document 1: Japanese Patent No. 3397536

In the optical compensating device disclosed in Patent Document No. 3397536, however, since the lock ring is revolved to lock the compensating lens in its locking position, there is a necessity for an additional actuator used for the locking besides the one used for driving the compensating lens. In addition, in order to engage the frame of the compensating lens with the cams in the lock ring to hold the compensating lens stationary, the compensating lens is locked steadily, resisting the pushing force of the cams, and thus, a supporting mechanism for the compensating lens is to be reinforced more than it typically is as required.

Accordingly, an object of the present invention is to provide an actuator capable of locking a movable member in position without additional purpose-made components such as a lock ring, and another actuator used to drive them, and additionally to provide a lens unit and a camera having such an actuator, as well.

### SUMMARY OF THE INVENTION

The present invention, which is made in order to overcome the aforementioned prior art disadvantages, provides an actuator for translating a photographing lens within a plane orthogonal to an optical axis of the lens so as to prevent image-shake, and the actuator comprising: a fixed member; a movable member holding the photographing lens; supporting means for supporting the movable member and permitting it to move within a plane in parallel with the fixed member; a driving means for translating and rotating the movable member relative to the fixed member; at least three engaging portions provided in the movable member; at least three receiving portions provided in the fixed member in corresponding positions to the engaging portions for contacting the engaging portions upon rotating the movable member to a predetermined locking position; and magnetic attracting means disposed separately in both the fixed member and the movable member, the magnetic attracting means, when they come close to each other, attracting each other and developing a force to rotate the movable member so that the engaging portions press on the receiving portions to lock the movable member in the locking position.

In the present invention configured in this manner, the movable member having the photographing lens is movably supported within a plane orthogonal to the fixed member by the supporting means. The driving means translates and revolve the movable member relative to the fixed member. As the movable member is rotated to the locking position, the three or more engaging portions provided in the movable member come in contact with the three or more receiving portions provided in the fixed member. The magnetic attracting means in both the fixed and movable members, when they come dose to each other, attract each other and develop a force to rotate the movable member, which results in the contacts pressing on the receiving portions so that the movable member is locked to the fixed member in position.

In the present invention configured in this manner, the movable member rotates and is locked by itself and therefore, the movable member can be retained stationary without providing additional members such as a lock ring and an actuator to activate them. The movable frame locks in the locking position by the attracting force of the magnetic attracting means, and therefore, in the event of an accidental deviation of the movable member from the locking position, the movable member can rapidly resume the locking position by virtue of the attracting force on and of the movable member. Since the movable member is retained in the locking position by the attracting force developed between the magnetic attracting means, a relatively small driving force is sufficient to displace the movable member to the locking position.

Preferably, when the movable member is positioned in normal operating areas where the movable member is moved to prevent image-shake, the magnetic attracting means are adapted to develop no attracting force exerted upon each other.

In the present invention configured in this manner, the magnetic attracting means develop no attracting force exerted upon each other in the event of positioning the movable member in the normal operating areas, and therefore, the magnetic attracting means would not give any adverse effect on the image-shake suppressing control by the movable frame in the normal operating areas.

According to the present invention, preferably, the locking position of the movable member is a position where the optical axis of the photographing lens held in the movable member is substantially aligned with that of the remaining photographing lens and where the movable member is rotated out of the normal operating areas.

In the present invention configured in this manner, the photographing lens held in the movable member and the remaining photographing lens are retained almost coaxial with each other during displacing the movable member to the locking position from the normal operating areas where the image-shake suppressing control is conducted. Thus, an image focused on the focusing plane is not influenced with a significant fluctuation during the displacement of the movable member to the locking position, and therefore, a user would not feel disagreeable to his or her manipulation.

In accordance with the present invention, preferably, the driving means includes a plurality of driving coil provided in one of the fixed member and the movable member; and a plurality of driving-magnet member in the other of the fixed member and the movable member in corresponding positions to the driving coils, and at least one of the driving magnet members serving as part of the magnetic attracting means.

In the present invention configured in this manner, since the driving magnet members of the driving means function as part of the magnetic attracting means, the magnetic attracting means in the fixed member or the movable member can be omitted.

According to the present invention, preferably, each of the driving coils has a first wiring segment, and a second wiring segment where current flows reverse in direction to that which flows in the first wiring segment, and each of the driving magnet members includes a first magnetic segment faced to the first wiring segment, and a second magnetic segment faced to the second wiring segment for applying magnetic line of force to the second wiring segment in a direction reverse to that which the first magnetic segment applies; the movable member, when displaced to the locking position, being initially accelerated toward the locking position, and then applying substantially no driving force in the succeeding stage.

In the present invention configured in this manner, since the locking position can be defined in an area where the first winding segment and the first magnetic segment are not faced to each other, and so are the second winding segment and the second magnetic segment, the locking position can be somewhere considerably away from the normal operating areas without an increase in dimensions of the driving coils and the driving magnet members.

The present invention also provides a lens unit comprising: a lens barrel; a plurality of photographing lens housed inside the lens barrel; and the actuator according to the present invention, having part of the photographing lenses held in the movable member.

The present invention further provides a camera comprising: a camera body; and the lens unit according to the present invention.

Thus, the actuator, and the lens unit and the camera with the actuator according to the present invention permit the movable member to lock in position without additional purpose-made components such as a lock ring, and an actuator to activate them.

### BRIEF DESCRIPTION OF THE DRAWINGS

FIG. 1 is a sectional view of a first preferred embodiment of a camera according to the present invention.

FIG. 2 is a front view of an actuator having its movable frame in an image-shake suppressing control position.

FIG. 3 is a front view of the actuator having its movable frame in a locking position.

FIG. 4 is a vertical sectional view taken along the line IV-IV of FIG. 3.

FIG. 5A is a vertical sectional view along the line V-V of FIG. 2 while FIG. 5B is a perspective view illustrating a driving magnet member being magnetized.

FIG. 6A is a graph illustrating relations between a relative position of a driving coil to the driving magnet member and the driving force excited on the driving magnet member, and FIG. 6B to FIG. 6E depict relative positions of the driving coil to the driving magnet member at points ‘b’ to ‘e’ denoted in the graph.

FIG. 7 is a diagram illustrating a movement of the driving magnet member in relation with signals output from a hole device.

FIG. 8 is a diagram illustrating a positional relation of the driving magnet member to the hole device.

FIG. 9 is a block diagram showing a signal processing by a controller.

FIG. 10 is a diagram illustrating positional relations among the driving coils on a fixed frame and the driving magnet members on the movable frame.

FIG. 11 includes time-varying graphs where a state of ON/OFF switches incorporated in the controller is given in the uppermost level the state of shunt switches is in the middle level a level of the output signal from a shift controller is denoted by solid line in the bottom level, and a rotation position of the movable frame is denoted by broken line in the bottom level.

FIG. 12 is a diagram illustrating a preliminary position prior to an activation for locking the movable frame.

FIG. 13 is a diagram illustrating a breaking position at which current supplied to the driving coils is cut off.

FIG. 14 is a vertical sectional view illustrating positional relations among the driving coil, the driving magnet member, and the magnetic member in the locking position.

FIG. 15 is a front view illustrating positional relations among the driving coil the driving magnet member, and the magnetic member in the locking position.

### BEST MODE TO IMPLEMENT THE INVENTION

With reference to the accompanying drawings, preferred embodiments according to the present invention will now be described.

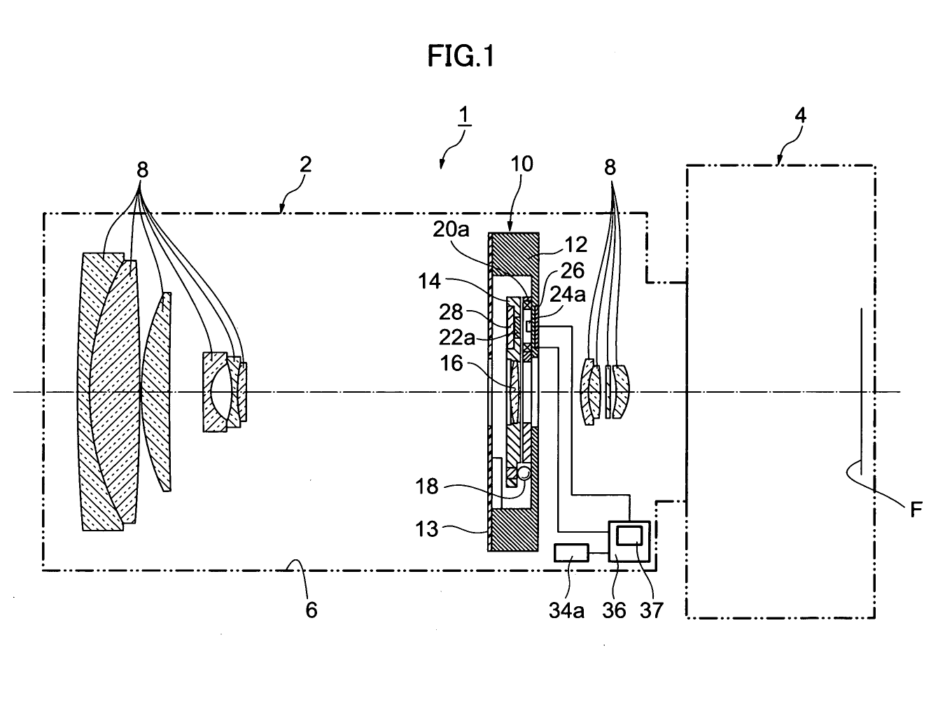

First, referring to FIG. 1 to FIG. 15, an embodiment of a camera according to the present invention will be detailed. FIG. 1 is a cross-sectional view of the embodiment of camera.

As shown in FIG. 1, a camera 1 has a lens unit 2 and a camera body 4. The lens unit 2 has a lens barrel 6, a plurality of photographing lens pieces 8 disposed within the lens barrel an actuator 10 moving one of the photographing lens pieces 8, namely, an image-shake compensating lens 16 within a predetermined plane, and gyros 34a, 34b serving as vibration sensors for detecting vibrations of the lens barrel 6 (only 34a is shown in FIG. 1).

The lens unit 2 is attached to the camera body 4 and is configured to focus the incident light onto a film plane F.

The lens barrel 6, which is roughly cylindrical in shape, holds the plurality of the photographing lens pieces 8 therein, and moving part of them enables an appropriate focusing adjustment over the entire lens optics.

The camera 1 of this embodiment renders the gyros 34a, 34b detect vibrations, and the detection results are used to activate the actuator 10 and then move the image-shake compensating lens 16, so as to stabilize the focusing of an image on the film plane F within the camera body 4. In this embodiment, the gyros 34a, 34b are piezoelectric vibrator gyros. Although, in this embodiment, the image-shake compensating lens 16 is of a single lens piece, the image stabilizing lens may be of a group of lens pieces.

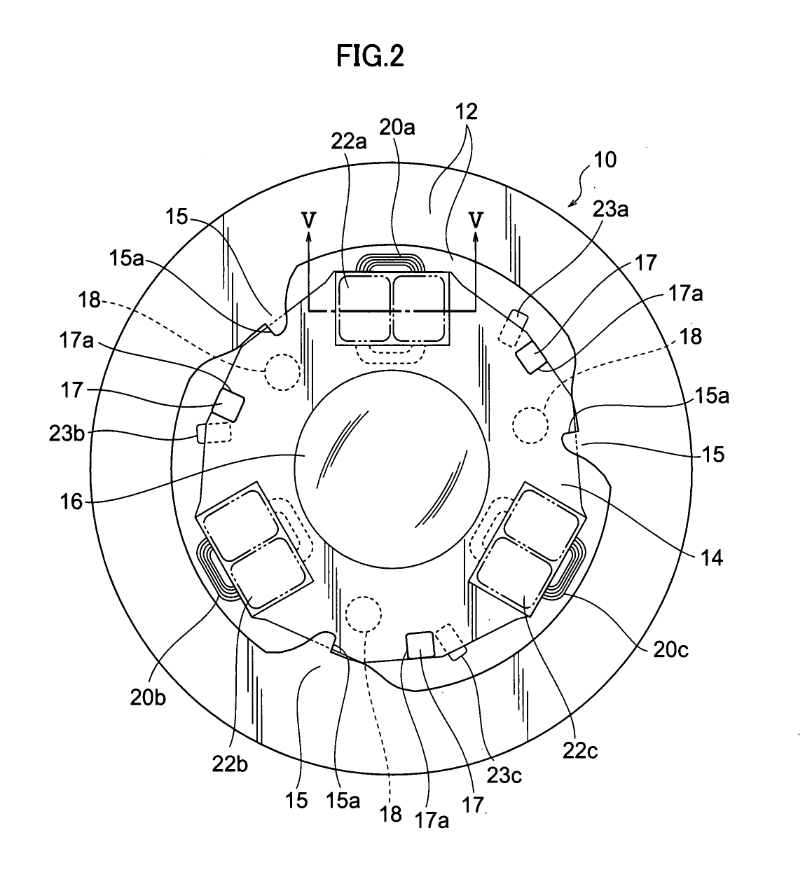

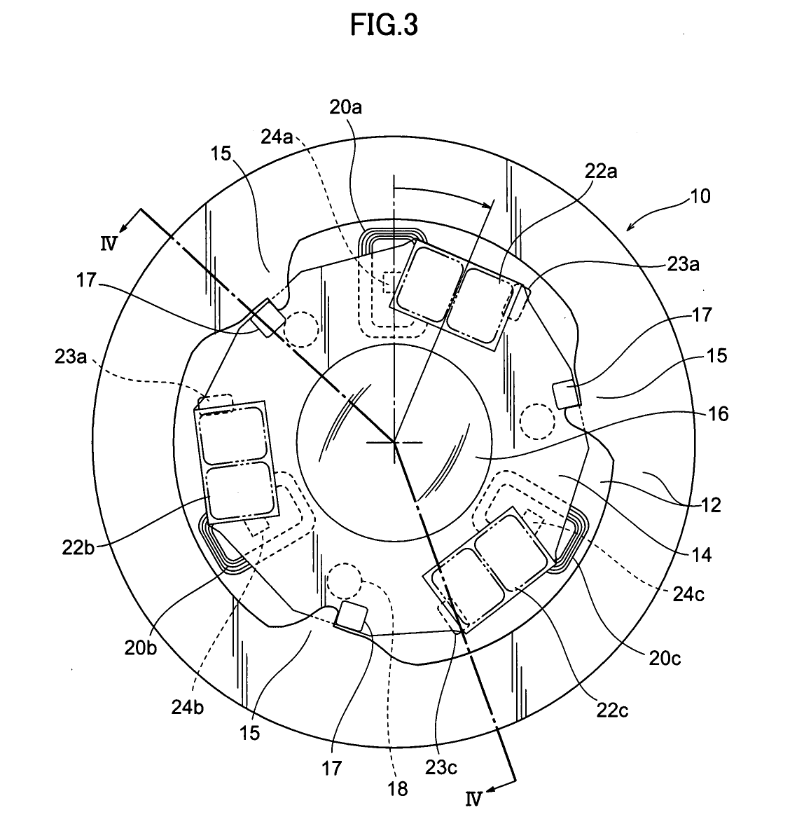

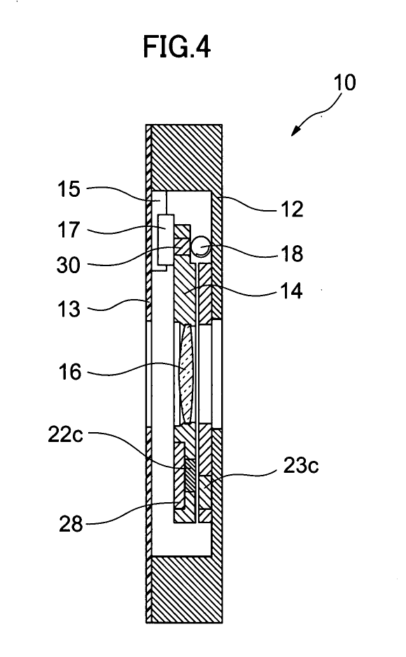

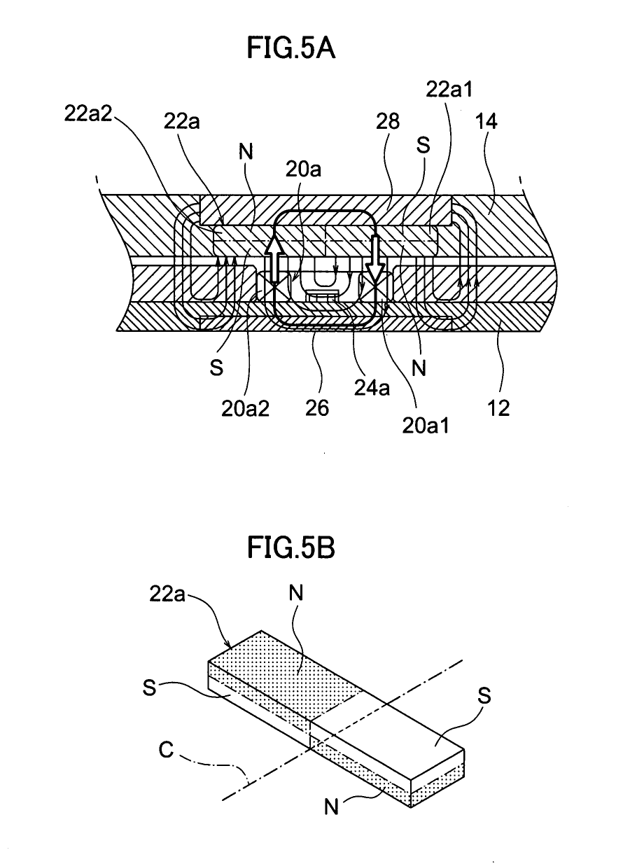

Referring to FIG. 2 and FIG. 5, an exemplary configuration of the actuator 10 will be detailed. FIG. 2 is a frontal view of the actuator 10 having its movable frame positioned for the control to prevent image-shake. FIG. 3 is a frontal view of the actuator 10 having its movable frame positioned for the engagement to lock it. FIG. 4 is a side sectional view taken along the line IV-IV of FIG. 3 and FIG. 5A is a side sectional view along the line V-V of FIG. 2. FIG. 5B is a perspective view illustrating driving magnet members being magnetized.

As can be seen in FIG. 2 to FIG. 5, the actuator 10 has a fixed frame 12 serving as a fixed member fixed to and inside the lens barrel 6, a movable frame 14 serving as a movable member movable relative to the fixed frame 12, and three steel balls 18 (FIG. 4) serving as a supporting means for supporting movable member. The actuator 10 further has three driving coils 20a, 20b, 20c attached to the fixed frame 12 and three driving magnet elements 22a, 22b, 22c attached to the movable frame 14 in corresponding positions facing the driving coils 20a, 20b, 20c, respectively.

Further, as shown in FIG. 5A, the actuator 10 has attracting yokes 26 and back yokes 28, and the attracting yokes 26 are attached to the fixed frame 12 to permit magnetic force of the driving magnet members 22a, 22b, 22c to attract the movable frame 14 to the fixed frame 12 while the back yokes 28 are attached to a reverse or front side of the driving magnet members 22 to permit the magnetic force of the driving magnet members 22 to effectively direct toward the fixed frame 12. Also, as shown in FIG. 4, the actuator 10 additionally has attracting magnet members 30 to attract the steel balls 18 to the movable frame 14. The driving coils 20a, 20b, 20c and three of the driving magnet members 22a, 22b, 22c correspondingly positioned to face the coils cooperatively function as a driving means for translating and revolving the movable frame 14 relative to the fixed frame 12.

In addition, as shown in FIG. 5A, hole devices 24a, 24b, 24c serving as magnetic sensors are disposed respectively in hollow insides of the windings of the driving coils 20a, 20b, 20c (only 24a is depicted in FIG. 5). The hole devices 24a, 24b, 24c detect magnetism of their respective faced driving magnet members 22a, 22b, 22c to determine a position of the movable frame 14 relative to the fixed frame 12. The hole devices 24a, 24b, 24c along with the driving magnet members 22a, 22b, 22c work as a position detecting means.

Also, as shown in FIG. 1, the actuator 10 has a controller 36 serving as a control means that, in response to vibrations detected by the gyros 34a, 34b and position data on the movable frame 14 detected by the hole devices 24a, 24b, 24c, controls current to apply to the driving coils 20a, 20b, 20c, respectively. The controller 36 has a shift controller 37 to shift the movable frame 14 toward the targeted position or the desired locking position where the movable frame is to be locked.

The actuator 10 enables the movable frame 14 to move within a plane in parallel with the film plane F relative to the fixed frame 12 secured to the lens barrel 6, and this results in the image-shake compensating lens 16 attached to the movable frame 14 being displaced so as to focus an image on the film plane F without any disturbance despite vibrations of the lens barrel 6.

The fixed frame 12 is a roughly doughnut-shaped disk, having a rim in its outer periphery, and three of the driving coils 20a, 20b, 20c are disposed thereon. As will be recognized in FIG. 2, the three driving coils 20a, 20b, 20c have their respective centers on a single circle of which center is coincident with a point of the optical axis of the lens unit 2. In this embodiment, the driving coil 20a is located on an extension line orthogonal to the optical axis while the remaining driving coils 20b, 20c are respectively separated by a central angle of 120 degrees different ways from the driving coil 20a. More specifically, the driving coils 20a, 20b, 20c are equidistance from the optical axis and equiangular from one another. The driving coils 20a, 20b, 20c have their respective wirings wound in a rounded rectangular shape of which center line is partially coincident with a radius of the circle about the optical axis.

The movable frame 14 is a roughly doughnut-like shaped circular plate inside the fixed frame 12, being surrounded by the rim of the fixed frame 12. The image-shake compensating lens 16 is fitted in a center hole of the movable frame 14. The driving magnet members 22a, 22b, 22c, which are respectively shaped in a rectangular, are embedded in the movable frame 14 along its circular extension in corresponding positions facing the driving coils 20a, 20b, 20c, respectively. Positions “facing the driving coils” referred to as herein are positional ranges in which a magnetic field brought by any of the driving coils substantially takes effects. On the reverse or front side of the driving magnet members 22, namely, on the side opposite to that which has the driving coils disposed, the rectangular back yokes 28 attached so that a magnetic flux from the driving magnet members 22 is effectively directed toward the fixed frame 12.

On the reverse or rear side of the driving coils on the fixed frame 12, namely, on the side opposite to the movable frame 14, the attracting yokes 26, which are respectively shaped in a rectangular, are attached. The magnetic force, which the driving magnet members 22 exert on the attracting yokes 26 in corresponding positions to them, causes the movable frame 14 to be attracted to the fixed frame 12. In this embodiment, the fixed frame 12 is made of non-magnetic material so that magnetic line of force of the driving magnet members 22 can effectively reach the attracting yokes 26.

The magnetic force exerted by the driving magnet members 22 will now be described with reference to FIG. 5. The driving magnet members 22a, 22b, 22c, the back yokes 28, and the attracting yokes 26 are respectively shaped in a rectangle and have their respective longer sides aligned with one another and their respective shorter sides also aligned with one another. The driving coils 20a, 20b, 20c have their respective longer sides laid in parallel with those of the mated rectangular back yoke 28 and their respective shorter sides also laid in parallel with the shorter sides of the same. The driving magnet members 22 are oriented so that magnetization border C, namely, the boundary between adjacent magnetic poles is coincident with a radius of the circle on which the driving magnet members 22 are spotted.

In this way, the driving magnet 22a, the back yokes 28, and the attracting yokes 26 together constitute a magnetic circuit where the magnetic line of force is circulated as denoted by arrows in FIG. 5A. Driving force tangential to the circle is exerted on the driving magnet member 22a as its faced driving coil is supplied with current. As with the remaining driving coils 20b, 20c, disposed in the similar cooperative positions are the remaining twos of the driving magnet members 22, the back yokes 28, and the attracting yokes 26.

The “magnetization boarder C″ referred to as herein is the boundary between the adjacent magnetic poles when the opposite ends of any of the driving magnet members 22 are magnetized and polarized in S-pole and N-pole. Thus, in this embodiment, the magnetization border C is determined as passing through midpoints of all the longer sides of the rectangular driving magnet members 22. Also, as shown in FIG. 5B, the driving magnet member 22a has its polarity varied as it goes in a thicknesswise direction from one major surface to the other, and FIG. 5B depicts the lower left of the driving magnet member assuming S-polarity, the lower right N-polarity, the upper left N-polarity, and the upper right S-polarity, respectively.

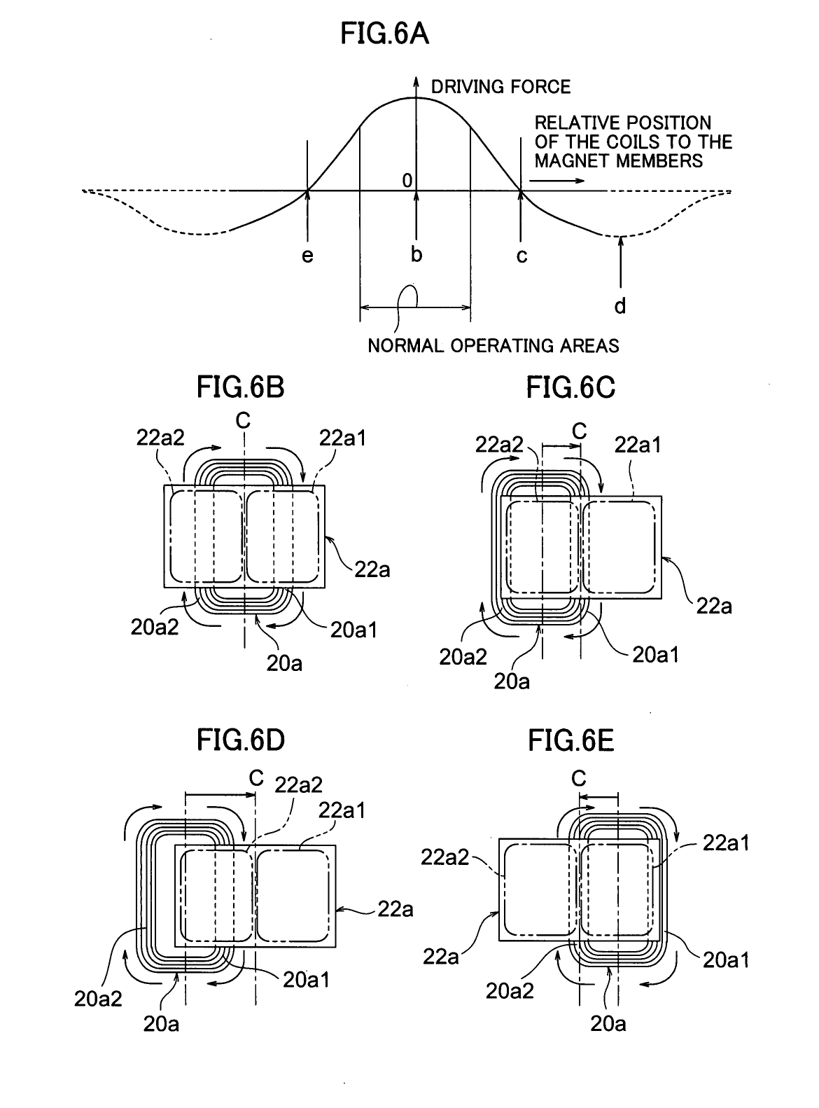

The driving force applied to the driving magnet members 22 will now be described with reference to FIG. 5 and FIG. 6. FIG. 6A is a graph illustrating relative positions between the driving coils and the driving magnet members in relation with the driving force applied to the driving magnet members, and FIG. 6B to FIG. 6E depict the relative positions between the driving coils and the driving magnet members at points ‘b’ to ‘e’ in the graph of FIG. 6A

First, as shown in FIG. 5A, a right half of the driving magnet member 22a, namely, a first magnetic segment 22a1 produces the magnetic line of force going down in FIG. 5A in a right extreme of first wiring segment 20a1 of the driving coil 20a. Reverse to this, a left half of the driving magnet member 22a, namely, a second magnetic segment 22a2 produces the magnetic line of force going up in FIG. 5A in a left extreme of a second wiring of the driving coil 20a.

As the current flows in the driving coil 20a as denoted by arrows in FIG. 6B, a flow of the current is directed from back to front in FIG. 5A in the first winding segment 20a1 of the driving coil 20a while it is directed from front to back in FIG. 5A in a second wiring segment 20a2. When such current flows in the magnetic field developed by the driving magnet member 22a, produced is a driving force that urges the driving magnet member 22a to the right in FIG. 5A.

As shown in FIG. 6A, the driving force is maximized when the driving magnet member 22a and the driving coil 20a are positioned as depicted in FIG. 6B, namely, when the magnetization border C of the driving magnet member 22a is coincident with the center of the driving coil 20a. The driving force is reduced as the driving magnet member 22a is deviated rightward or leftward away from the point of the maximized force. When the driving magnet member 22a is moved rightward to a position as depicted in FIG. 6C (i.e., Point ‘c’ in FIG. 6A), the driving force is decreased to be naught. As the driving magnet member 22a continues to move and then reaches a position as depicted in FIG. 6D (i.e., Point ‘d’ in FIG. 6A), the driving force is reversed in direction, and the driving magnet member 22a is urged by the driving force in the leftward direction. In this situation where the driving force is reversed, the driving magnet 22a is influenced simply by the driving force developed between the second magnetic segment 22a2 and the first winding segment 20a1 of the driving coil 20a. Thus, the maximum level of the driving force in a range where the driving force is reversed is smaller than that in the state depicted in FIG. 6B.

On the other hand, when the driving magnet member 22a is moved leftward, the driving force is reduced to be naught as the driving magnet member 22a reaches a position as depicted in FIG. 6E (i.e., Point ‘e’ in FIG. 6A). As the driving magnet member 22a continues to move leftward, the driving force is reversed in direction, and the leftward driving force is applied to the driving magnet 22a.

The driving force described so far is that which is developed by virtue of the clockwise flow of the current in the driving coil 20a in the state depicted in FIG. 6B, and the counterclockwise flow of the current in the driving coil 20a causes a complete reversal of the driving force. Specifically, the counterclockwise flow of the current in the driving coil 20a develops the leftward driving force in an area covering Point ‘e’ to Point ‘c’ in FIG. 6A but does the rightward driving force in areas on the left exceeding Point ‘e’ and on the right exceeding Point ‘c’, respectively. Although the driving force developed between the driving coil 20a and the driving magnet member 22a has already been explained, those which are developed between the remaining faced twos of the driving coils and the driving magnet members are completely the same.

In the actuator 10 of the camera 1 in this embodiment, the first windings of the driving coil and the first magnetic segment of the driving magnet member are faced to each other while second windings of the driving coil and a second magnetic segment of the driving magnet member are similarly faced to each other, and in the normal operating areas where the driving force is satisfactory, the control over the image-shake suppressing control is conducted. In addition, when the movable frame 14 is locked, the position where that frame is held stationary is out of the normal operating areas, and the first windings of the driving coil and the second magnetic segment of the driving magnet member are faced to each other in this position.

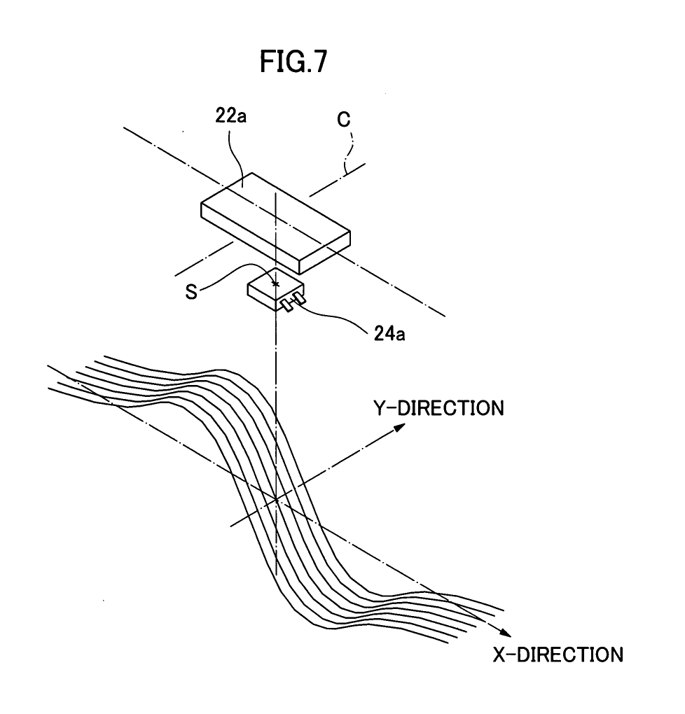

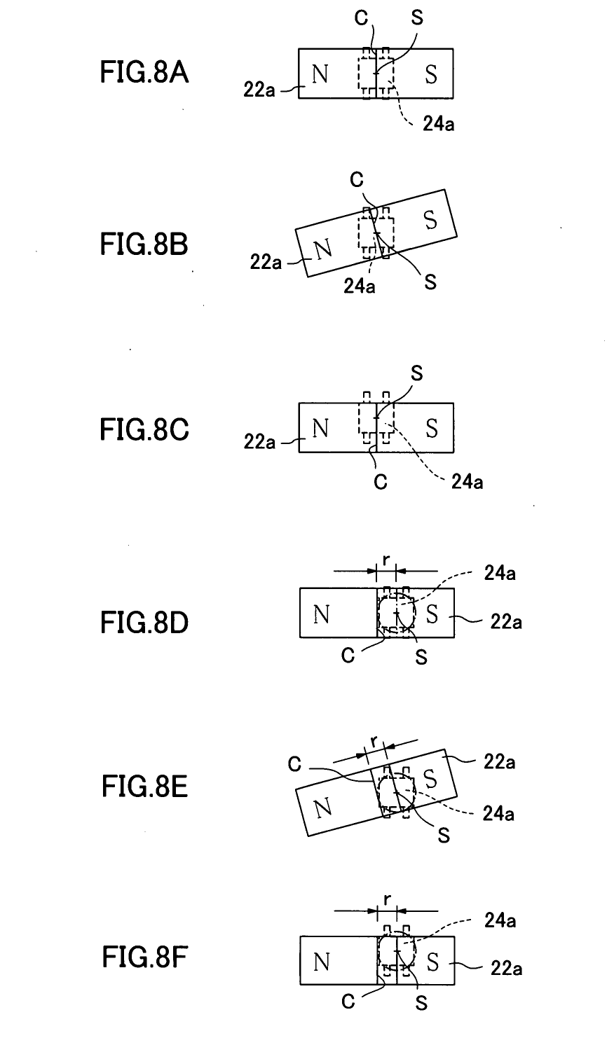

With reference to FIGS. 7 and 8, it is described how to detect the position of the movable frame 14.

FIGS. 7 and 8 illustrate the movement of the driving magnet member 22a in relation with signals produced from the hole device 24a. As shown in FIG. 7, when the center of sensitivity S of the hole device 24a is in the magnetization border C of the driving magnet member 22a, a signal output by the hole device 24a is naught in level As the movable frame 14 moves along with the driving magnet member 22a thereon, and the center of sensitivity of the hole device 24a deviates from the magnetization border of the driving magnet member 22a, the signal from the hole device 24a is varied. As will be recognized in FIG. 7, as the driving magnet member 22a moves to become orthogonal to the magnetization border C, namely, as it lays itself on and along the X-axis in the illustrated two dimensions, the hole device 24a generates a sinusoidal signal Thus, when a displacement of the driving magnet member 22a is minute, the hole device 24a produces a signal almost in proportion to the displacement. In this embodiment, when the displacement of the driving magnet member 22a falls within a range as small as 3% of the longer side of the driving magnet member 22a, the signal from the hole device 24a is almost in proportion to a distance from the center of sensitivity S of the hole device 24a to the magnetization border of the driving magnet member 22a. Also, in this embodiment, the actuator 10 works, in the normal operating areas, satisfying a condition that the output signal from the hole device is proportion to the displacement of the driving magnet member.

As can be seen in FIG. 8A to FIG. 8C where the center of sensitivity S of the hole device 24a is in the magnetization border C of the driving magnet member 22a, in either of the events that the driving magnet member 22a has rotated as in FIG. 8B and that the driving magnet 22a has shifted along the magnetization border C as in FIG. 8C, the output signal from the hole device 24a is naught in level. Further, as shown in FIG. 8D to FIG. 8F where the center of sensitivity S of the hole device 24a is deviated from the magnetization border C of the driving magnet border 22a, the hole device 24a produces a signal in proportion to a distance ‘r’ from the center of sensitivity S to the magnetization border C. Thus, assuming that the distance ‘r’ between the center of sensitivity S and the magnetization border C remains unchanged, the signals output from the hole device 24a are all the same in level in any of the events that the driving magnet member 22a has moved in a direction orthogonal to the magnetization border C as in FIG. 8D, that the driving magnet member 22a has translated and rotated as in FIG. 8E, and that the driving magnet member 22a has translated in an arbitrary direction as in FIG. 8F.

Although the hole device 24a has been detailed so far, the remaining hole devices 24b, 24c produce signals in the similar fashion, satisfying positional conditions relative to their respective faced driving magnet members 22b, 22c. Thus, the position of the movable frame 14 as a result of the translating and/or rotating movement relative to the fixed frame 12 can be determined in response to the signals detected by the hole devices 24a, 24b, 24c.

Referring to FIG. 2 to FIG. 4, the locking mechanism of the movable frame 14 will be described below.

As in FIGS. 2 and 3, the fixed frame 12 is provided with three receiving portions 15 that extend in radial directions from the rim. The receiving portions 15 are spotted 120-degree equiangular from one another in conformity with the circular dimensions of the fixed frame 12. The movable frame 14 is provided with three engaging portions 17 to come in contact with the receiving portions 15 on the one-to-one basis, which are also equiangular by 120 degrees from one another in conformity with the circular dimensions of the movable frame 14. The engaging portions 17 have their respective contact surfaces 17a adapted to come in contact and mated with receiving surfaces 15a of the receiving portions 15.

Also, as in FIG. 3, the three pairs of the contact surfaces 17a and receiving surfaces 15a are configured so that three pairs of them come simultaneously in contact with each other as the movable frame 14 is rotated with the image-shake compensating lens 16 is coaxial with the remaining photographing lens pieces 8. More specifically, rotating the movable frame 14 and rendering the three pairs of the contact surfaces 17a and the receiving surfaces 15a come in contact all at the same time permit the movable frame 14 to mechanically be locked in the predetermined locking position.

Although the contact surfaces 17a and the receiving surfaces 15a to respectively mate with them are planar in their abutting areas that extend along radii of circles about the optical axis, there is an unavoidable shape tolerance in such abutting planar areas, and hence, in some microscopic view, the contact surfaces 17a and the receiving surfaces 15a are in point contact with each other. Thus, the position of the movable frame 14 is not completely defined by two pairs of the contact surfaces 17a and the receiving surfaces 15a, but a manner in which the remaining pair of them come in contact uniquely define the locking position of the movable frame. When the movable frame 14 is stationed in the locking position, the image-shake compensating lens 16 and the remaining photographing lens pieces 8 are coaxial with one another.

Moreover, as shown in FIG. 2 and FIG. 3, three locking magnetic members 23a, 23b, 23c, which serve as a magnetic attracting means, are spotted on the fixed frame 12, being separated from one another by 120 degrees along a circular extension of the fixed frame 12. The locking magnetic members, when locked as in FIG. 3, act with and react against their respective corresponding driving magnet members to develop attracting force, which forces the movable frame 14 to rotate in the clockwise direction in FIG. 3. This rotating force causes the contact surfaces 17a to bump on the receiving surfaces 15a, and this permits the movable frame 14 to lock in the desired position. In this way, the driving magnet members 22a, 22b, 22c in this embodiment are also a functional part of the magnetic attracting means. In the normal operating areas of the movable frame 14, since the driving magnet members are fully apart from any of the locking magnetic members, substantially no attracting force is developed between them.

Then, with reference to FIG. 2 to FIG. 4, The supporting mechanism with the steel balls 18 to the movable frame 14 will be described.

As can be seen in FIG. 2 and FIG. 3, three of the steel balls 18 are spotted between the fixed frame 12 and the movable frame 14. The steel balls 18 are equidistant by 120 degrees from each other about the centers of the circular extensions of the frames, being respectively interposed between the adjacent driving coils. As shown in FIG. 4, the steel balls 18 are attracted to the movable frame 14 by the attracting magnet members 30 embedded in the movable frame 14 in corresponding positions to mate with the steel balls 18. The movable frame 14 is attracted toward the fixed frame 12 by virtue of the driving magnet members 22 while the steel balls 18 are attracted to the movable frame 14 by the attracting magnet member 30, and hence, the steel balls 18 are held between the fixed frame 12 and the movable frame 14. In this way, the movable frame 14 can be supported on the plane parallel to the fixed frame 12, and as the steel balls 18 sandwiched between the faced frames, the movable frame 14 is permitted to translate and revolve in arbitrary directions relative to the fixed frame 12.

In this embodiment, the steel balls 18 are of spherical steel body but not limited to this in shape. In other words, the steel balls 18 may assume any shape if only a part where they are in contact with the fixed frame 12 and the movable frame 14 is roughly spherical in shape. Such a shape is referred to as “spherical” herein

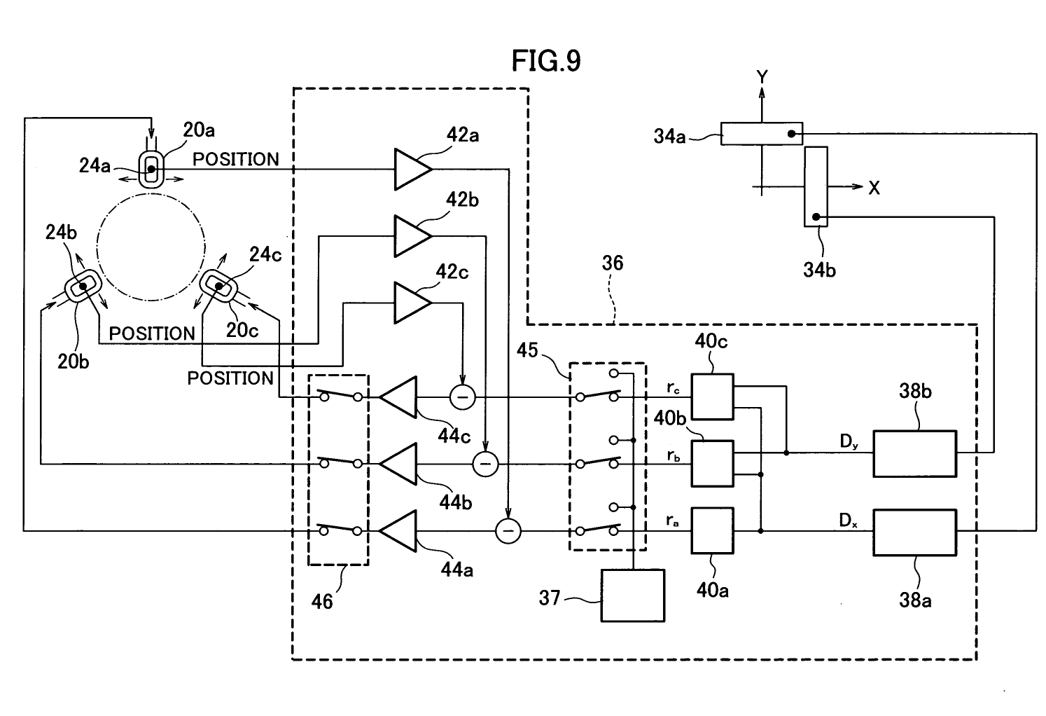

The image-shake suppressing control by the actuator 10 will now be described with reference to FIG. 9. FIG. 9 is a block diagram showing an exemplary signal processing in the controller 36. As shown in FIG. 9, two of the gyros 34a, 34b momentarily detect the lens unit 2 vibrating and produce the detection results to arithmetic operation circuits 38a, 38b that are built in the controller 36 and serve as lens position command signal generators. In this embodiment, the gyro 34a detects an angular velocity of the yawing by the lens unit 2 while the gyro 34b detects the angular velocity of the pitching by the same.

The arithmetic operation circuits 38a, 38b produce a lens position command signal in response to the angular velocity momentarily sent from the gyros 34a, 34b to give commands in time sequence on a targeted position to which the image-shake compensating lens 16 is to be displaced. More specifically, the arithmetic operation circuit 38a integrates the angular velocity of the yawing detected by the gyro 34a over time to calibrate optical properties as desired, thereby producing horizontal components Dₓ of the lens position command signal and similarly, the arithmetic operation circuit 38b produces vertical components D_{y} of the lens position command signal in response to the angular velocity of the pitching detected by the gyro 34b. Momentarily moving the image-shake compensating lens 16 as requested by the lens position command signal received as mentioned above, an image focused on the film plane F within the camera body 4 is steadied without fluctuation even if the lens unit 2 is vibrated during admitting the light in the photographing.

The coil position command signal generating means built in the controller 36 is adapted to generate a coil position command signal individually for the driving coils in response to the lens position command signal produced by the arithmetic operation circuits 38a, 38b, respectively. The coil position command signal is that which represents relative positions of the driving coils 20a, 20b, 20c to their respective mated driving magnet members 22a, 22b, 22c when the image-shake compensating lens 16 is shifted as requested by the lens position command signal. Once the driving magnet members 22 respectively facing the driving coils are shifted as requested by the coil position command signal for each driving coil, the image-shake compensating lens 16 is moved to a position as requested by the lens position command signal In this embodiment, since the driving coil 20a is located vertically right above the optical axis, the coil position command signal rₐ for the driving coil 20a is identical with the horizontal components Dₓ of the lens position command signal produced from the arithmetic operation circuit 38a. Thus, an arithmetic operation circuit 40a, which serves as a means for producing the coil position command signal to position the driving coil 20a, produces the output transferred from the arithmetic operation circuit 38a in the earlier step, as it has been without change. The coil position command signals, r_{b} and rₒ, which are respectively to position the driving coils 20b and 20c, are produced in response to the horizontal components Dₓ of the lens position command signal and the vertical components D_{y} of the same by arithmetic operation circuits 40b, 40c respectively serving as a coil position command signal generator.

A displacement or an amount of the movement of the driving magnetic members 22 relative to their respective corresponding driving coils, which are determined by the hole devices 24a, 24b, 24c, respectively, is amplified at a given magnification ratio by magnetic sensor amplifiers 42a, 42b, 42c, respectively. Driving circuits 44a, 44b, 44c supply their respective associated driving coils 20a, 20b, 20c with current by an amount in proportion to a differential between the coil position command signals rₐ, r_{b}, r_{c} and the signals output from the magnetic sensor amplifiers 42a, 42b, 42c. Thus, when such a differential is not detected any longer as existing between the coil position command signals and the outputs from the magnetic sensor amplifiers, or namely, once the driving magnet members reach the positions requested by the coil position command signals, no current flows in the driving coils, resulting in the driving force upon the driving magnet members turning to be naught. Switches 45 interposed between the arithmetic operation circuits 40a, 40b, 40c and their respective associated driving circuits 44a, 44b, 44c are configured to be unfailingly switched into direct connecting position in the image-shake suppressing control mode. ON/OFF switches 46 interposed between the driving circuits 44a, 44b, 44c and the associated driving coils 20a, 20b, 20c are configured to be unfailingly switched into the position connecting the driving circuits and the associated driving coils.

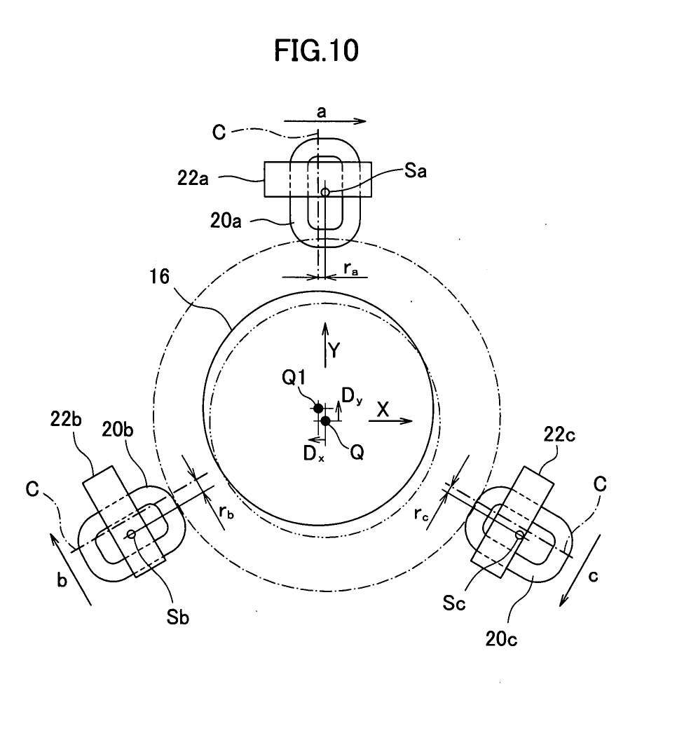

With reference to FIG. 10, a relation between the lens position command signal and the coil position command signal will now be described in terms of translating the movable frame 14. FIG. 10 is a diagram of the relative positioning among the driving coil members 20a, 20b, 20c attached to the fixed frame 12 and the driving magnet members 22 on the movable frame 14. The three driving coils 20a, 20b, 20c are centered respectively at points Sa, Sb, Sc in the same circle of which radius and center are designated by R and Q where the center Q of the circle is the original or zero point of coordinates on X-Y dimensions. The hole devices 24a, 24b, 24c share the points Sa, Sb, Sc as their respective center of sensitivity S. When the movable frame 14 is at a reference point of its capable trajectories during the image-shake compensating operation, the center of the image-shake compensating lens 16 and the optical axis of the photographing lens 8 are coincident with each other while the midpoints of the magnetization borders C in the driving magnet members 22 are also located at the points Sa, Sb, Sc, respectively, where the magnetization boarders C are directionally coincident with radii of the circle about the center Q. The movable frame 14 translates along an extension passing this reference point to execute the image-shake suppressing control.

It is now assumed that the image stabilizing lens or the image-shake compensating lens 16, which has a center Q1 and is initially in the original point Q of the coordinates on the X-Y dimensions with the horizontal axis X and the vertical axis Y, is translated by a distance +D_{y} along the Y-axis and by a distance −Dₓ along the X-axis. As the movable frame 14 is displaced in this manner, the magnetization borders C in the driving magnet members 22 are respectively shifted toward positions as represented by hyphen-dot line as denoted in FIG. 10. It is additionally assumed that the magnetization border C in the driving magnet member 22a associated to the driving coil 20a is deviated by rₐ from the point Sa, the magnetization border C in the driving magnet member 22b associated to the driving coil 20b is deviated by r_{b} from the point Sb, and the magnetization border C in the driving magnet member 22c associated to the driving coil 20c is deviated by r_{c} from the point Sc. The distances, rₐ, r_{b}, r_{c} are equivalent to those which are to be detected by the hole devices 24a, 24b, 24c after moving the image stabilizing lens 16 by +D_{y} along the Y-axis and −Dₓ along the X-axis. These distances rₐ, r_{b}, r_{c} are uniquely determined to the displacement Dₓ along the X-axis and the displacement D_{y} along the Y-axis. Thus, if it is required to move the image stabilizing lens 16 by Dₓ along the X-axis and D_{y} along the Y-axis, the uniquely determined distances rₐ, r_{b}, r_{c} are individually given as the coil position command signal.

With a definition that the displacement in a positive direction is designated by arrows a, b, c in FIG. 10 in conformity with reference symbols for the distances rₐ, r_{b}, r_{c}, relations of the distances rₐ, r_{b}, and r_{c} with the displacements Dₓ and D_{y} are given by formulae as follows:

$${r}_{a} = {D}_{x} \\ {r}_{b} = - \frac{1}{2} {D}_{x} + \frac{\sqrt{3}}{2} {D}_{y} \\ {r}_{c} = - \frac{1}{2} {D}_{x} - \frac{\sqrt{3}}{2} {D}_{y} \qquad ( 1 )$$

The arithmetic operation circuits 40a, 40b, 40c described in conjunction with FIG. 9 perform arithmetic operations pursuant to the above mentioned formulae (1) and respectively produce the coil position command signal.

The generation of the coil position command signal will now be described in terms of rotating the movable frame 14 instead of translating the same. In order to rotate the movable frame 14, the same value is applied as the coil position command signal for three of the coils members. More specifically, the following coil position command signal is given to rotate the movable frame 14 in the clockwise direction by an angle (in radians):

rₐ=Rθ

r_{b}=Rθ (2)

r_{c}=Rθ

In this way, all the driving magnet members 22 are moved by the same distance in the directions tangential to the circle on which their respective mated driving coils are spotted, and consequently, the movable frame 14 is revolved about the optical axis while the image-shake compensating lens 16 and the optical axis of the photographing lens pieces 8 are coaxial with each other.

Referring to FIG. 1 and FIG. 9, improved features of the embodiment of camera 1 of the present invention will be described. Initially, pressing a booting switch (not shown) in the camera 1 to turn on an image-shake suppressing function, the actuator 10 integrated in the lens unit 2 is activated. The gyros 34a, 34b provided in the lens unit 2 momentarily detect vibrations of a predetermined frequency band and then produce the detection results to the arithmetic operation circuits 38a, 38b built in the controller 36. The gyro 34a produces signals representing an angular velocity of the lens unit 2 in yawing directions, to the arithmetic operation circuit 38a while gyro 34b produces those in pitching directions to the arithmetic operation circuit 38b. The arithmetic operation circuit 38a integrates the received signal or the angular velocity over time to calculate a yawing angle and compensate the integration results on predetermined optical properties to generate the lens position command signal Dₓ designating the horizontal components. Similarly, the arithmetic operation circuit 38b integrates the received signal or the angular velocity over time to calculate a pitching angle and calibrates the integration results on the predetermined optical properties to generate the lens position command signal D_{y} designating the vertical components. The image-shake compensating lens 16 is momentarily positioned as requested by the lens position command signals output in time sequence from the arithmetic operation circuits 38a, 38b so as to steady the focusing and have an image without shaking on the film plane F within the camera body 4.

The lens position command signal Dₓ of the horizontal components output from the arithmetic operation circuit 38a is transferred to the arithmetic operation circuit 40a and then output as the coil position command signal rₐ to position the driving coil 20a. Additionally, the arithmetic operation circuit 40b receives both the lens position command signal Dₓ of the horizontal components and the lens position command signal D_{y} of the vertical components and then produces the coil position command signal r_{b} from the second or middle equation in the formulae (1) to position the driving coil 20b. Similarly, the arithmetic operation circuit 40c receives the lens position command signals Dₓ, D_{y} and then produces the coil position command signal r_{c} from the third or lowest equation in the formulae (1) to position the driving coil 20c.

The hole device 24a to mate with the driving coil 20a produces a detection signal to the magnetic sensor amplifier 42a. The detection signal amplified by the magnetic sensor amplifier 42a undergoes differentiation from the coil position command signal rₐ (i.e., the signal used to position the driving coil 20a), and the driving coil 20a is supplied with current in proportion to the resultant difference via the driving circuit 44a. Similar to this, after the differentiation between the detection signal from the hole device 24b and the coil position command signal r_{b}, the driving coil 20b is supplied with current in proportion to the resultant difference via the driving circuit 44b, and the driving coil 20c is supplied with current in proportion to the differentiation result between the detection signal from the hole device 24c and the coil position command signal r_{c}, via the driving circuit 44c.

The current flowing in the driving coils causes magnetic field in proportion to it. The magnetic field excites the driving magnet members 22 disposed to face respectively with the driving coils and forces them to come closer to the positions requested by the coil position command signals rₐ, r_{b}, r_{c}, respectively, thereby displacing the movable frame 14. When the driving magnet members 22 thus excited reach the positions respectively requested by the coil position command signals, the coil position command signals and the detection signals from the hole devices become equivalent in signal level to each other to turn the outputs from the driving circuits to be naught, and this results in the driving magnet members completely losing the driving force to naught. Once some external disturbance, alternation in the coil position command signals, or the like causes the driving magnet members 22 to deviate from the positions requested by the coil position command signals, the driving coils are supplied with current again, and thus, the driving magnet members 22 are pulled to the requested positions.

The aforementioned operations are momentarily repeated so that the image-shake compensating lens 16 mounted on the movable frame 14 with the driving magnet members 22 is moved in compliance with the lens position command signals. In this way, the resultant image focused on the film plate F within the camera body 4 is steadied.

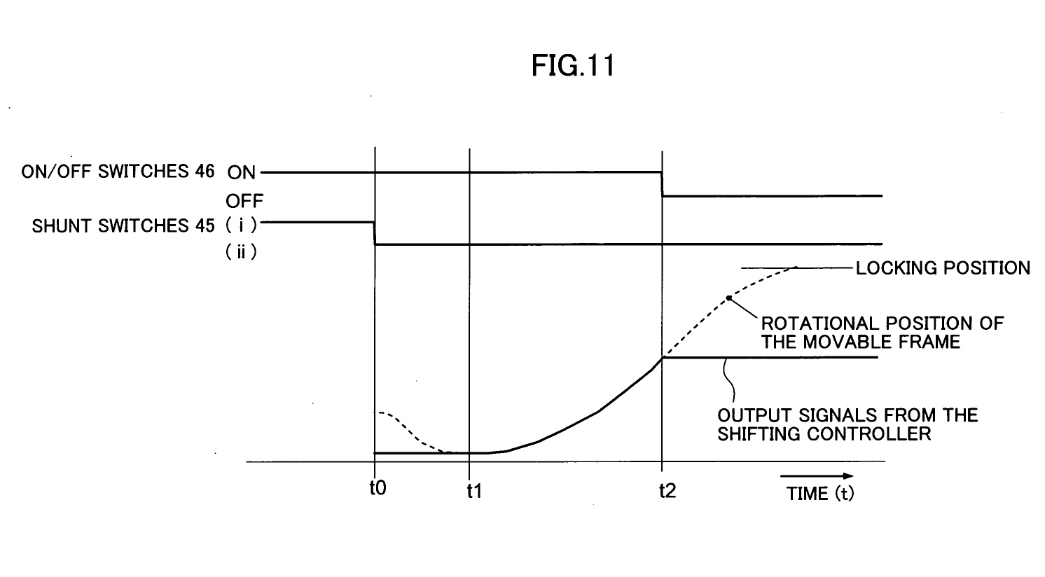

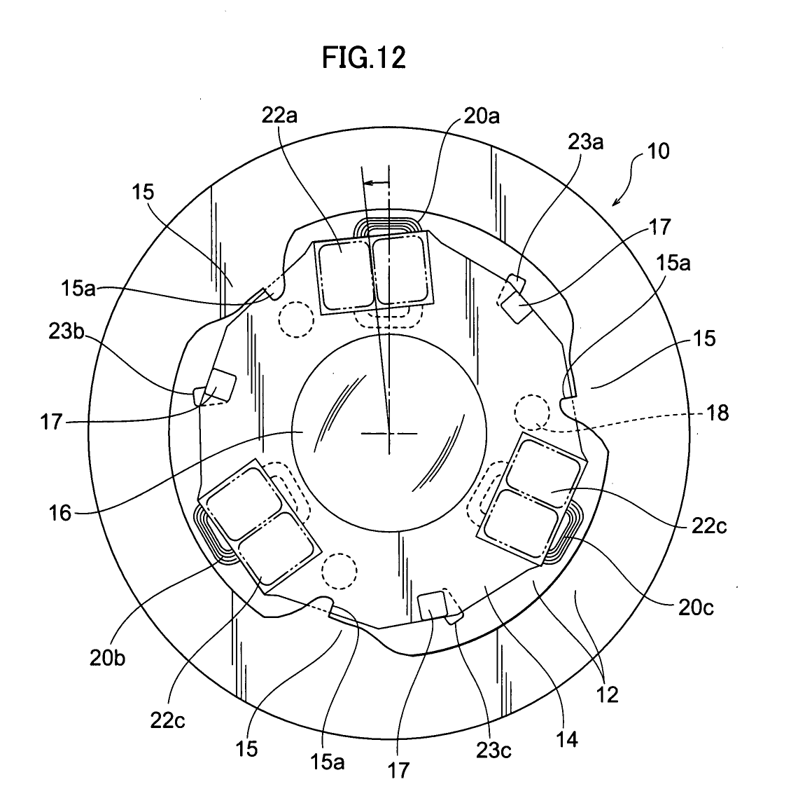

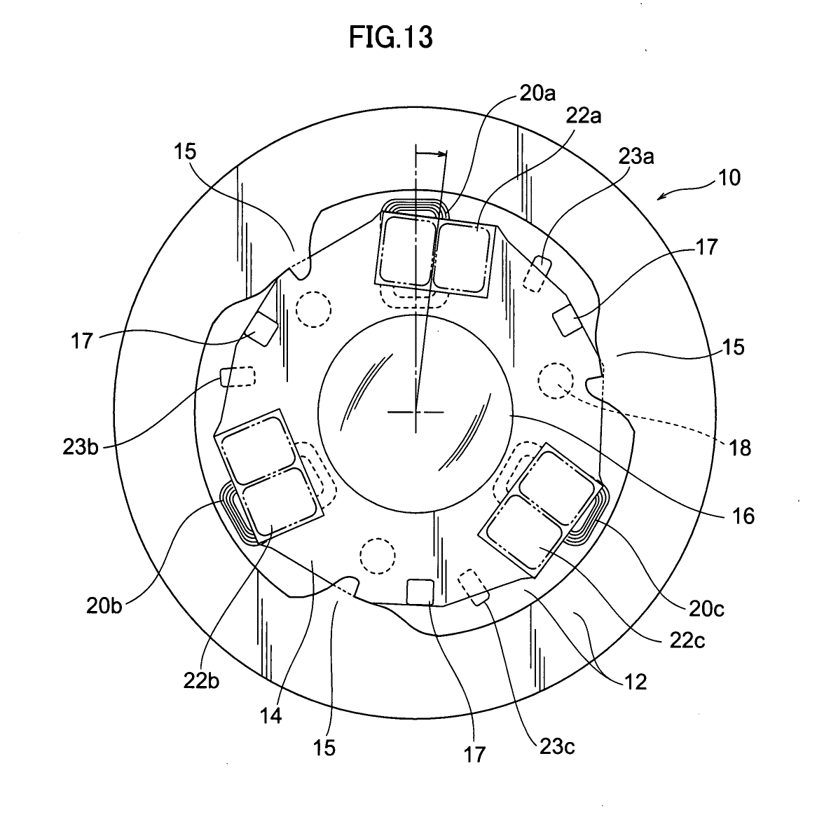

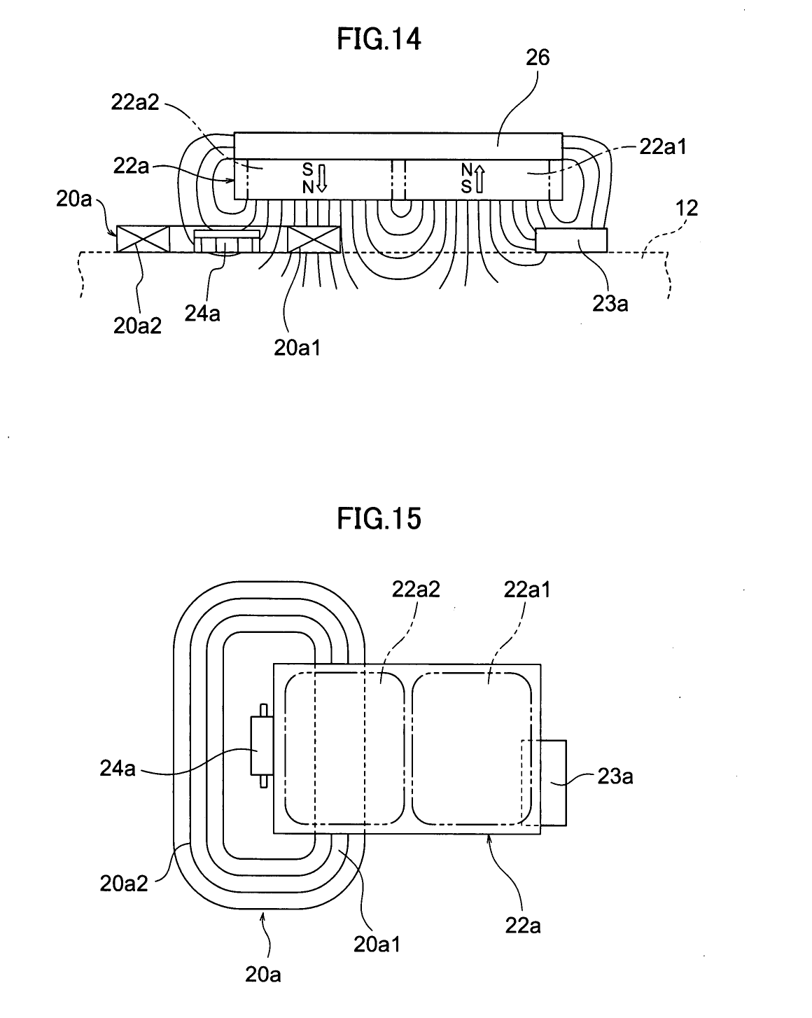

Referring to FIG. 2, FIG. 3, and FIG. 9 to FIG. 15, operations of the shift controller 37 built in the controller 36 will now be described. FIG. 11 includes time-varying graphs where a state of ON/OFF switches 46 incorporated in the controller 36 is given in the uppermost level the state of the shunt switches 45 is in the middle level a level of the output signal from the shift controller 37 is denoted by solid line in the bottom level and a rotation position of the movable frame 14 is denoted by broken line in the bottom level. FIG. 12 is a diagram illustrating a preliminary position prior to the activation for locking the movable frame 14, and FIG. 13 is a diagram illustrating a breaking position at which the current supplied to the driving coils is cut off FIG. 14 is a vertical sectional view illustrating positional relations among the driving coil 20a, the driving magnet 22a, and the magnetic member 23a in a locking position, and FIG. 15 is a front view of FIG. 14.

At time t0 in FIG. 11, turning on a switch (not shown) incorporated in the lens unit 2 causes the shift controller 37 is booted. Concurrent with this, as will be recognized in the graph in the middle level in FIG. 11, the ON/OFF switches 45 in the controller 36 flips from a normal activation position (i) to a connecting position (ii) where the shift controller 37 is connected to the driving circuits 44a, 44b, 44c. This results in the driving circuits respectively receiving output signals from the shift controller 37 instead of the coil position command signals rₐ, r_{b} , r_{c}.

As designated by solid line in the graph in the bottom level of FIG. 11, signals to displace the movable frame 14 to the preliminary position shown in FIG. 12 are produced from time t0 to time t1 subsequent to booting the shift controller 37. The preliminary position is defined as a position in which the image-shake compensating lens 16 and the photographing lens pieces 8 are coaxial with each other and also as a position obtained by rotating the movable frame 14 a certain angle away from the locking position (in the counterclockwise direction in FIG. 12). At time t0, when the shift controller 37 produces the command signals to move the movable frame 14 to the preliminary position, current in proportion to a deviation of the current position of the movable frame 14 from the preliminary position flows in the driving coils 20a, 20b, 20c, respectively, and the movable frame 14 is urged to move. Such driving force renders the movable frame 14 move to the preliminary position by time t1.

During a period of time from time t1 to time t2, the shift controller 37 produces command signals to accelerate the movable frame 14 toward to the locking position. The movable frame 14 is forced to move to be pursuant to the command signals. Specifically, the movable frame 14, having the image-shake compensating lens 16 and the photographing lens pieces 8 be coaxial with each other, is accelerated in the clockwise direction in FIG. 12. In this way, the movable frame 14 reaches the driving force breaking position shown in FIG. 13 at time t2.

At time t2, the shift controller 37 turns the ON/OFF switches 46 off. This causes the current flowing in the driving coils to be cut off, and regardless of the command signals output from the shift controller 37, the driving force urging the movable frame 14 to move turns to be naught. In this embodiment, the driving force breaking position is a relative position between the driving coils and the driving magnet members as recognized in FIG. 6C.

The movable frame 14 accelerated in the clockwise direction continues to rotate in the clockwise direction due to the moment of inertia after the driving force is cut off at time t2, and eventually, it reaches the locking position as depicted in FIG. 3. In the locking position, the contact surfaces 17a of the engaging portions 17 come in contact with the receiving surfaces 15a of the receiving portions 15, and thus, the movable frame 14 is locked and secured to the fixed frame 12. Since the coincidence of the optical axis of the image-shake compensating lens 16 with that of the photographing lens pieces 8 is imperfect while the movable frame 14 is being rotated, any one of three of the mated contact surfaces 17a and receiving surfaces 15a come in contact with each other first. After the initial contact, the movable frame 14 continues to move because of the moment of inertia till both the remaining two of them respectively come in contact.

When the movable frame 12 perfectly reaches the locking position, as shown in FIG. 14 and FIG. 15, the first magnetic segment 22a1 of the driving magnet member 22a is brought closer to the locking magnetic member 23a, and hence, the driving magnet member 22a is pulled rightward in FIG. 14. Similarly, the first magnetic segments 22b1, 22c1 of the driving magnet members 22b, 22c are attracted by the locking magnetic members 23b, 23c, respectively, and the attracting force urges the movable frame 14 to rotate in the clockwise direction in FIG. 3. The rotation of the movable frame causes the contact surfaces 17a of the engaging portions 17 to press on the receiving surfaces 15a of the receiving portions 15, and thus, the movable frame 14 is anchored in the locking position.

In the event that some external force impacts the camera 1 while the movable frame 14 is retained in the locking position, the movable frame 14 breaks the attracting force by the driving magnet members and is slightly shifted from the locking position. In such a case, the driving magnet members exert the rotating force in the clockwise direction upon the movable frame 14, and hence, the movable frame is rotated reversely, or in the clockwise direction from the current position, which results in the contact surfaces 17a coming in contact with the receiving surfaces 15a again to rapidly render the movable frame 14 resume the locking position.

In order to force the movable frame 14 to resume the normal operating areas, the controller 36 supplies a predetermined amount of current to the driving coils. Specifically, as shown in FIG. 14 and FIG. 15, the second magnetic segment 22a2 of the driving magnet member 22a is faced to the first wiring segment 20a1 of the driving coil 20a when the movable frame is in the locking position. Thus, supplying the driving coil 20a with the current causes driving force to be developed between the second magnetic segment 22a2 of the driving magnet member 22a and the first wiring segment 20a1 of the driving coil 20a. In this way, a development of the driving force in the counterclockwise direction results in the driving magnet member 22a being pulled away from the locking magnetic member 23a.

The current flowing in the driving coil 20a to make the movable frame 14 resume the normal operating areas is reversed in direction to the current supplied to displace the movable frame 14 in the counterclockwise direction. Furthermore, accelerating the movable frame 14 in the counterclockwise direction from the locking position to the normal operating areas till it reaches the driving force breaking position as shown in FIG. 6C, the current supplied to the driving coils is cut off. In this manner, the movable frame 14 utilizes the moment of inertia to resume the normal operating areas.

In the preferred embodiment of the camera according to the present invention, the movable frame rotates and locks by itself and therefore, the movable frame can be retained stationary in position without providing additional members such as a lock ring, and an actuator to activate them.

In this embodiment of camera, additionally, the movable frame is locked by the attracting force developed between the driving magnet members and the locking magnetic members, and therefore, after an interruption of activating the camera, the movable frame is still retained in the locking position.

Further, in the embodiment of camera according to the present invention, the movable frame is retained in the locking position by the attracting force developed between the driving magnet members and the locking magnetic members, and therefore, in the event of an accidental deviation of the movable frame from the locking position, the attracting force quickly permits the movable frame to resume the locking position. Moreover, in this embodiment, since the movable frame is retained in the locking position by the attracting force between the driving magnet members and the locking magnetic members, the movable frame can be moved to the locking position by a relatively small driving force.

In the embodiment of camera of the present invention, the movable frame, when positioned in the normal operating areas, is fully apart from the locking magnetic members, and therefore, the attracting force developed between the driving magnet members and the locking magnetic members would not give any adverse effect on the image-shake suppressing control by the movable frame.

In the embodiment of camera of the present invention, the locking position of the movable member is defined so that the image-shake compensating lens and the photographing lens are coaxial with each other, and therefore, displacing the movable frame to the locking position permits the lenses to be almost coaxial with each other. In this way, there would not be a significant fluctuation of the image focused on the film plane, and thus, a user would not feel disagreeable to his or her manipulation.

In the embodiment of camera of the present invention, the attracting force developed by the driving magnet members is utilized to lock the movable frame in the locking position, and therefore, a scheme to retain the movable frame in position can be simplified.

Furthermore, in the embodiment of camera of the present invention, the movable frame is initially accelerated to continue to move with no driving force applied in the succeeding stage till it reaches the locking position, and therefore, the locking position can be defined in a segment where the first winding segment and the first magnetic segment are not faced to each other, and so are the second winding segment and the second magnetic segment. In this way, the locking position can be somewhere considerably away from the normal operating areas without an increase in dimensions of the driving coils and the driving magnet members.

Although the preferred embodiments of the present invention have been described, various modifications can be made to them. Especially, in the aforementioned embodiments, the invention is applied to film cameras, but the invention can be applied to any camera, such as digital cameras, video cameras, and the like. The present invention can also be applied to lens units that are used in combination with camera bodies of these various cameras.

Further, although the driving magnet members are used as a magnetic attracting means disposed on the movable frame in the aforementioned preferred embodiments, some other magnet components may be disposed on the movable frame besides the driving magnet members. Also, in the aforementioned embodiments, the driving magnet members on the movable frame and the locking magnetic members on the fixed frame cooperatively serve as a magnetic attracting means, but such a magnetic attracting means may be made of a pair of magnetic and non-magnetic elements or a pair of magnetic elements.

What is claimed is:

1. An actuator for translating a photographing lens within a plane orthogonal to an optical axis of the lens so as to prevent image-shake, and the actuator comprising:
a fixed member;
a movable member holding the photographing lens;
supporting means for supporting the movable member and permitting it to move within a plane in parallel with the fixed member;
a driving means for translating and rotating the movable member relative to the fixed member;
at least three engaging portions provided in the movable member;
at least three receiving portions provided in the fixed member in corresponding positions to the engaging portions for contacting the engaging portions upon rotating the movable member to a predetermined locking position; and
magnetic attracting means disposed separately in both the fixed member and the movable member, the magnetic attracting means, when they come close to each other, attracting each other and developing a force to rotate the movable member so that the engaging portions press on the receiving portions to lock the movable member in the locking position.

2. An actuator according to claim 1, wherein, when the movable member is positioned in normal operating areas where the movable member is moved to prevent image-shake, the magnetic attracting means are adapted to develop no attracting force exerted upon each other.

3. An actuator according to claim 2, wherein the locking position of the movable member is a position where the optical axis of the photographing lens held in the movable member is substantially aligned with that of the remaining photographing lens and where the movable member is rotated out of the normal operating areas.

4. An actuator according to claim 1, wherein the driving means includes a plurality of driving coil provided in one of the fixed member and the movable member; and a plurality of driving magnet member in the other of the fixed member and the movable member in corresponding positions to the driving coils, and at least one of the driving magnet members serving as part of the magnetic attracting means.

5. An actuator according to claim 4, wherein each of the driving coils has a first wiring segment, and a second wiring segment where current flows reverse in direction to that which flows in the first wiring segment, and each of the driving magnet members includes a first magnetic segment faced to the first wiring segment, and a second magnetic segment faced to the second wiring segment for applying magnetic line of force to the second wiring segment in a direction reverse to that which the first magnetic segment applies; the movable member, when displaced to the locking position, being initially accelerated toward the locking position, and then applying substantially no driving force in the succeeding stage.

6. A lens unit comprising:
a lens barrel
a plurality of photographing lens housed inside the lens barrel; and
the actuator according to claim 1, having part of the photographing lenses held in the movable member.

7. A camera comprising:
a camera body; and
the lens unit according to claim 6.
